(19) United States
(12) Patent Application Publication
(10) Pub. No.: US 2010/0005723 A1
(43) Pub. Date: Jan. 14, 2010

(54) CONTROL SYSTEM AND TEST RELEASE DEVICE FOR AN OVERHEAD DOOR

(76) Inventor: Rob J. Evans, Peoria, AZ (US)

Correspondence Address: SCHMEISER OLSEN & WATTS, 18 E UNIVERSITY DRIVE, SUITE # 101, MESA, AZ, 85201, US

(21) Appl. No.: 12/542,463

(22) Filed: Aug. 17, 2009

Related U.S. Application Data
(63) Continuation-in-part of application No. 11/084,667, filed on Mar. 18, 2005, now Pat. No. 7,574,826.
Application No. 11/084,667 is a continuation-in-part of application No. 10/964,041, filed on Oct. 12, 2004, now Pat. No. 7,591,102.
Application No. 10/964,041 is a continuation-in-part of application No. 10/845,748, filed on May 13, 2004.

(51) Int. Cl. E05F 3/00

(52) U.S. Cl. 49/322

(57) ABSTRACT

An overhead door control system includes an input shaft drivably connected to an overhead door axle and a load brake shaft drivably connected to the input shaft. The control system includes a load brake which releases the load brake shaft in response to rotation of the input shaft. The load brake engages the load brake shaft in response to the rotation of the input shaft being driven to zero.

### CROSS-REFERENCE TO RELATED APPLICATIONS

This application claims priority to U.S. Patent Application No. 2005, 10/845,748, which was filed on May 13, 2004, the contents of which are incorporated by reference as though fully set forth herein.

This application claims priority to U.S. patent application Ser. No. 10/964,041, which was filed Oct. 12, 2004, the contents of which are incorporated by reference as though fully set forth herein.

This application claims priority to U.S. patent application Ser. No. 11/084,667, which was filed on Mar. 18, 2005, the contents of which are incorporated by reference as though fully set forth herein.

### BACKGROUND OF THE INVENTION

1. Field of the Invention

This invention relates generally to doors and, more particularly, to overhead doors.

2. Description of the Related Art

Overhead doors of the past have a variety of drive input devices including hand crank mechanisms. These overhead doors include fire doors that are configured to permit the door to descend when an emergency condition is detected. Such a condition is detected by fusible links that hold the doors in spring tension under normal operation, but which release the spring tension when the fusible link is burned in a fire, for example. More information regarding doors can be found in U.S. Pat. Nos. 4,104,834, 5,386,891, 5,482,103, 6,484,784 and 6,605,910.

Mechanical governors are known in the overhead door art. These governors typically provide a ratcheting action mechanism or a series of gears for slowing the door in its descent.

Drive input devices of the past are permanent devices that are typically provided originally with the door. Fire door systems that are retrofitted to existing overhead doors may require replacement of the existing drive input mechanism including a motor.

With hand crank drive input devices of the past, a fusible link is typically incorporated in order to release the spring tension in the door to permit the door to descend as described above. A hand chain is drivingly connected with the door axle by a separate action, such as by manually pulling a lever when a user desires to raise or lower the door.

Test release devices of the past have placed slack in a cable in systems that release spring tension on the axle of the overhead door in an emergency condition. These systems are subsequently reset by restoring a proper amount of spring tension.

### BRIEF SUMMARY OF THE INVENTION

The present invention relates to an overhead door and control system including one or more of a test release device for testing a response to release by a fusible link and a drive input device for the overhead door. The novel features of the invention are set forth with particularity in the appended claims. The invention will be best understood from the following description when read in conjunction with the accompanying drawings.

### BRIEF DESCRIPTION OF THE DRAWINGS

FIG. 1A is a perspective view of a drive input device mounted for use with an overhead door in accordance with one embodiment of the present invention.

FIG. 1B is a front perspective view taken generally in a direction of arrow 1B of FIG. 1A.

FIG. 1C is a top plan view of the drive input of FIGS. 1A and 1B taken generally in a direction of arrow 1C in FIG. 1B; FIG. 2A is a sectional view taken along lines 2A-2A of FIG. 1C.

FIG. 2B is a sectional view taken along lines 2B-2B of FIG. 1C.

FIG. 2C is a diagrammatic view showing an alternative embodiment of a load brake mechanism.

FIG. 3 is a diagrammatic perspective view taken generally in a direction of arrow 3 of FIG. 1C.

FIG. 4A is perspective view of another embodiment of a drive input device in accordance with the present invention.

FIG. 4B is a sectional view taken generally along lines 4B-4B of the drive input device of FIG. 4A.

FIG. 4C is a detailed view of a region labeled 4C in FIG. 4B.

FIG. 5 is a diagrammatic view showing several components that may be connected to an electronic controller in accordance with the embodiments of FIGS. 1-4.

FIG. 6A is a diagrammatic front view of an automatic test release device usable together with overhead doors having fusible links in accordance with another embodiment of the test device.

FIG. 6B is a diagrammatic sectional view taken along lines 6B-6B of FIG. 6A.

FIG. 6C is a sectional view taken along lines 6C-6C of FIG. 6B.

FIG. 7A is a perspective view similar to FIG. 4A, but having a gear to gear driving mechanism thereon.

FIG. 7B is a diagrammatical end view taken in a direction of arrow 7B in FIG. 7A.

### DETAILED DESCRIPTION OF THE INVENTION

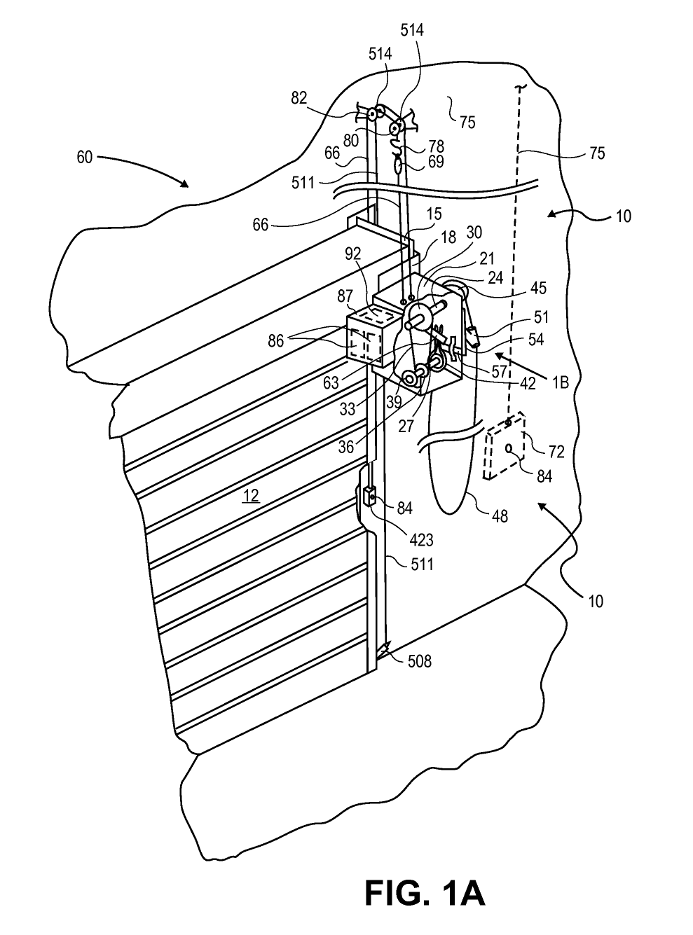

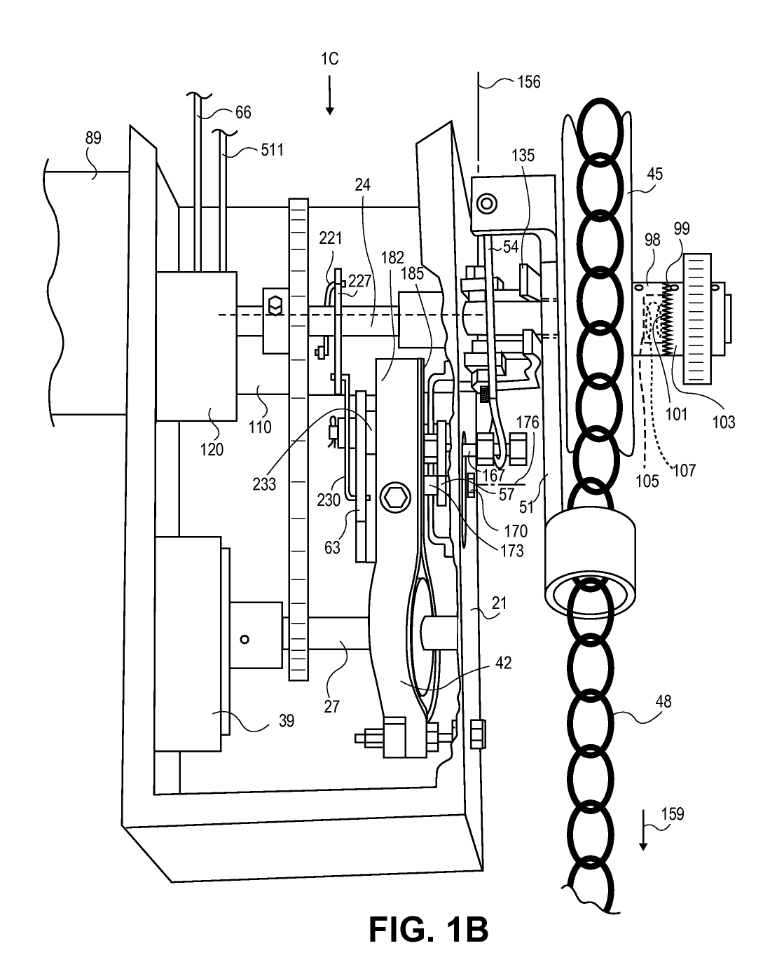

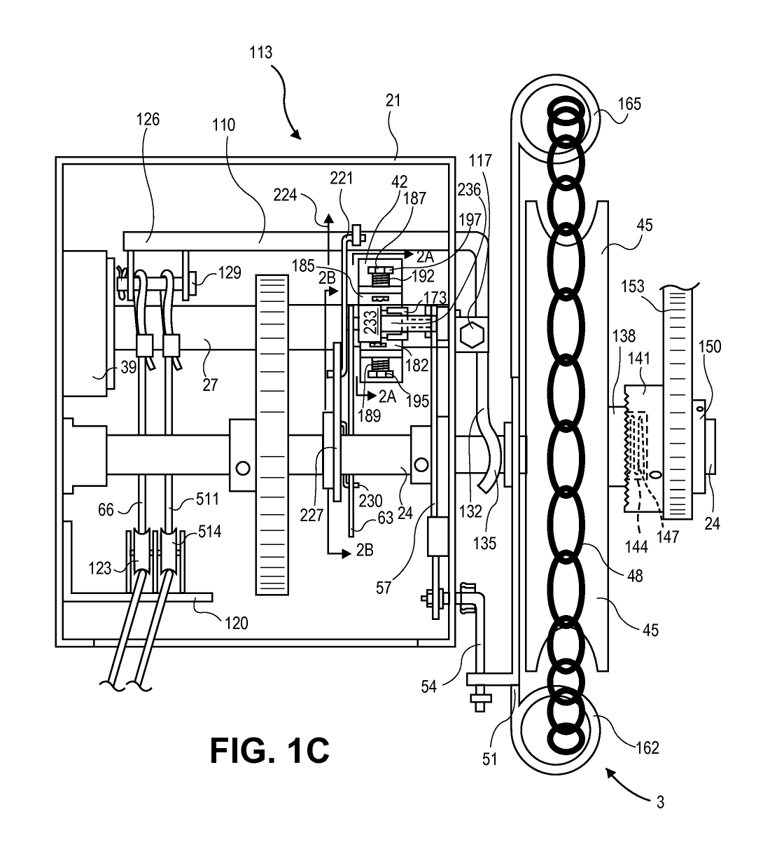

FIG. 1A is a perspective view of a drive input 10 mounted for use with an overhead door 12 in accordance with a first embodiment of the present invention. The drive input 10 may be supported on an end plate 15 of the overhead door 12. The end plate 15 may include a mounting plate, or a separate mounting plate 18 may be supported on the end plate 15. A drive input housing 21 may be supported on the mounting plate 18. The drive input housing 21 supports an input shaft 24 and a load brake shaft 27 extending generally parallel to each other. The input shaft 24 has an input shaft transfer sprocket 30 supported thereon in an interior of the housing 21. A load brake belt or chain 33 drivingly connects the input shaft 24 to the load brake shaft 27 via the transfer sprocket 30 and a load brake shaft sprocket 36. The load brake shaft 27 is controlled by either a first clutch 39 or a load brake 42. The first clutch 39 may be a centrifugal clutch of a type substantially similar to a go-cart clutch. The purpose of the first clutch 39 is to inhibit rotation of the load brake shaft above a predetermined maximum speed. The load brake 42, on the other hand, is configured to positively stop the load brake shaft 27 under normal conditions when no driving input via the input shaft 24 is present.

A pocket wheel or other input pulley 45 is supported on the input shaft 24 outside the housing 21. An endless element 48 may be provided in the form of a hand chain, for example. Under normal operating conditions, the input pulley 45 is non-rotatably supported on the input shaft 24. Thus, when a user pulls on the endless element 48, the input pulley 45 is rotated in one of two directions depending on whether the user desires to open or close the overhead door 12. The input shaft 24 also has an input shaft driving sprocket, (not shown in FIG. 1A), supported thereon and drivingly connected to an axle of the overhead door.

Advantageously, the endless element 48 passes through a guide in a bell crank 51 that is offset from a pivot point of the bell crank so that upon pulling of the endless element 48 by a user, the bell crank is rotated. The bell crank 51 is in turn connected to an actuator 54. The actuator 54 is therefore moved in response to rotation of the bell crank 51. The actuator 54 is connected to a hand crank lever 57 through a wall of the housing 21. The hand crank release lever 57 is operatively connected to the load brake 42 so that rotation of the bell crank results in releasing the load brake 42. Thus, whenever a user engages and pulls on the endless element 48, the load brake 42 is released. At all other times during normal operation, the load brake will be urged to positively engage and hold the drive load brake shaft 27, the input shaft 21, and the overhead door axle against movement.

The drive input device 10 of the present invention also includes an emergency release mechanism 60 that releases the load brake 42 and the input pulley 45 during emergency conditions such as in a fire or during loss of power over an extended period. The emergency release mechanism 60 is configured to release the load brake 42 by an emergency release lever 63 as will be described in greater detail below. As shown in FIG. 1A, a sash in a form of a line or cable 66 extends from an interior of the housing 21 upwardly to a fusible link 69. Inside the housing 21, the cable 66 is operatively connected to the emergency release lever 63 so that when the cable 66 is released, such as by burning of the fusible link 69, the emergency release lever 63 is actuated to release the load brake 42 as will be described in greater detail below. The cable 66 is also configured to actuate another portion of the emergency release mechanism that releases the input pulley 45 from its drivable connection to the input shaft 24 during an emergency condition.

As shown in FIG. 1A, the cable 66 may be connected to a test release device 72 or test release device 423 by a cable extension 75. To this end, the cable 66 may be extended by an “S” hook 78 that connects the cable 66 to the cable 75. The cables 66 and 75 may be supported and guided on rollers 80, 82, for example. The emergency release mechanism 60 includes at least one biasing element that, among other things, maintains the cables 66 and 75 in tension during normal operation of the drive input device 10. The test release device 72/423 has a test button 84. When the test button 84 is pressed, a portion of the cable 75 is paid out under the urging of the biasing element of the emergency release mechanism. Thus the cables 75 and 66 are shifted in a direction that simulates a release of the cable 66 by burning of the fusible link 69. Thus, as may be appreciated, a user may test the system for proper operation by simply pressing the button 84 of the test release device 72/423.

It is to be understood that the test release device may be located as indicated at numeral 423 or may be located at any position including remotely as indicated by the configuration of the test release device shown at 72 in FIG. 1A.

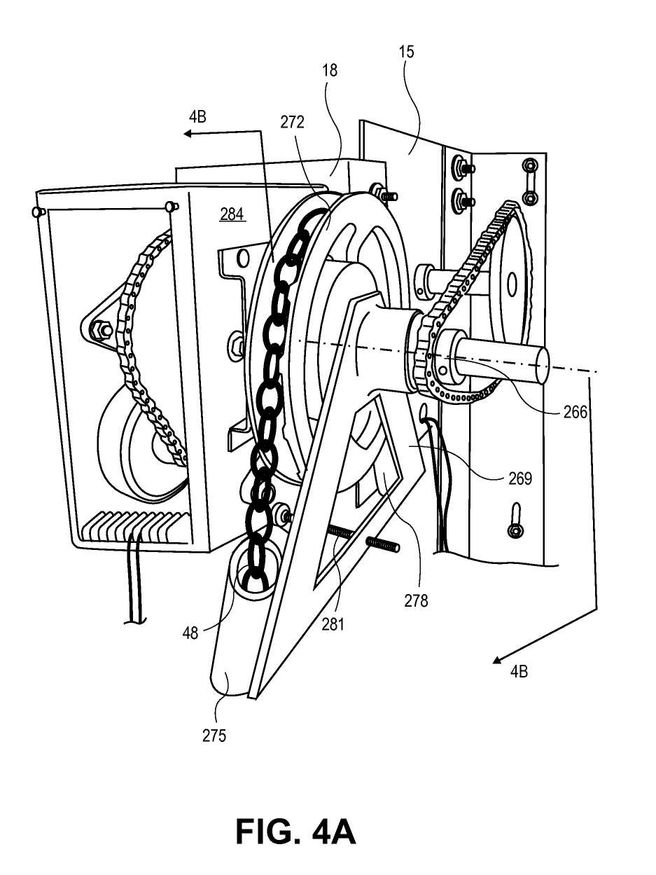

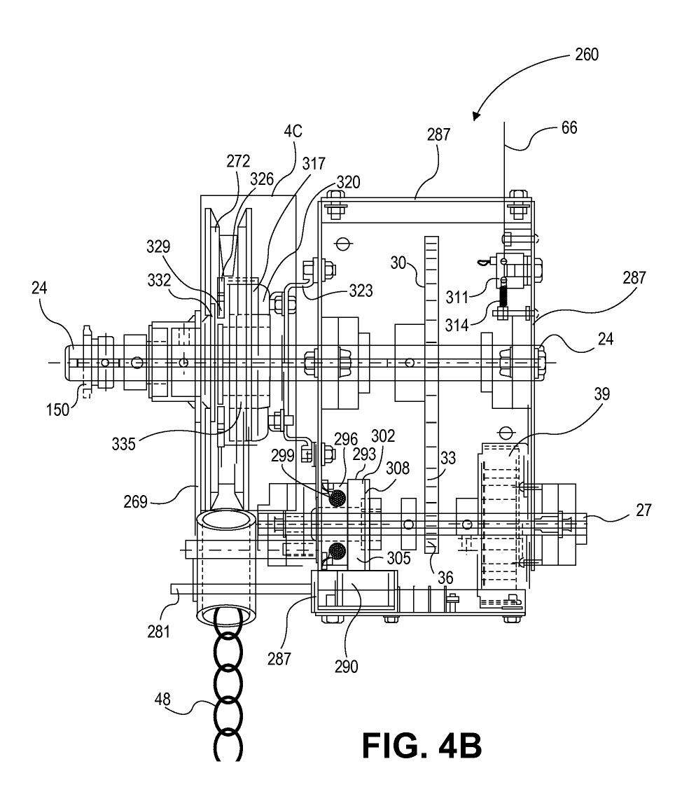

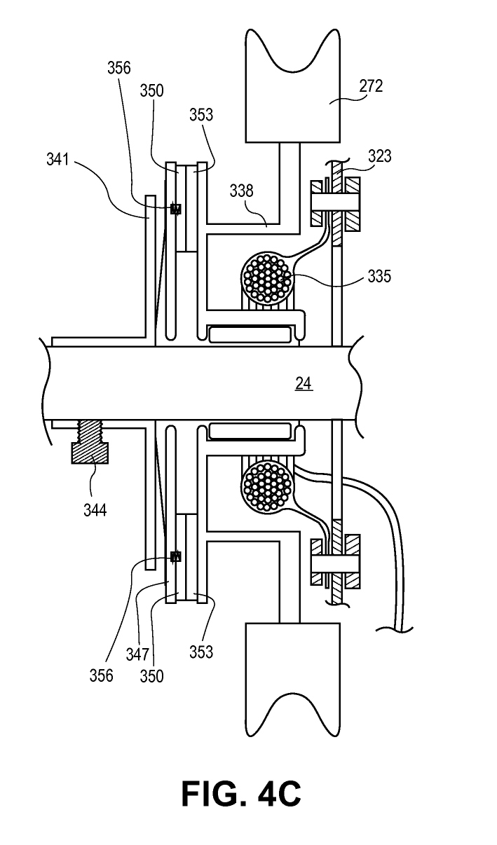

In order to power the test release device 72/423 one or more batteries 86 may be provided in a battery box 89 that may be mounted on an exterior of the housing 21, for example. Additionally, other electronic components including an electronic controller 92 may be located inside the battery box 89 for embodiments of the present invention that have more than simple on/off switching for the test release device, for example. By way of example and not by way of limitation, the drive input device 10 may be implemented together with a system that receives inputs from a building alarm system, or from any of a variety of sensors positioned at pertinent locations in a building. Furthermore, the drive input device 10 may be implemented with systems that include any of a variety of audio and/or visual warnings. In these cases, the electronic controller 92 may be configured or programmed in a predetermined manner to provide the desired audio and visual warnings, and/or other functions similar to my U.S. patent application Ser. No. 10/645,004, filed Aug. 20, 2003, and entitled FIRE DOOR CONTROL SYSTEM AND METHOD INCLUDING PERIODIC SYSTEM TESTING; U.S. patent application Ser. No. 10/631,315, filed Jul. 30, 2003, and entitled FIRE DOOR CONTROL SYSTEM AND METHOD; and U.S. patent application Ser. No. 10/777,502, filed Feb. 10, 2004, and entitled FIRE DOOR CONTROL SYSTEM, METHOD INCLUDING PERIODIC SYSTEM TESTING, AND CONTACTLESS SAFETY EDGE, all by Rob J. Evans, the disclosures of which are each incorporated herein by reference. Still Further, the electronic controller 92 may be configured or programmed to control electrically actuatable components as will be described with regard to FIGS. 4-6B.

As shown in FIG. 1B, the bell crank 51 is rotatably supported on the input shaft 24. The pocket wheel or input pulley 45 is also supported on the input drive 24. The pocket wheel 45 is normally held in a non-rotatable position by a toothed pocket wheel collar 98 having teeth 99 that engage in teeth recesses 101 of an input shaft connecter 103. A recess 105 inside the toothed pocket wheel collar 98 holds a resilient biasing element 107. The biasing element 107 urges the toothed pocket wheel collar 98 and the input pulley 45 away from the input shaft connecter 103. Thus, unless the input pulley 45 and the toothed pocket wheel collar 98 are held against the input shaft connecter 103, the input pulley 45 and toothed pocket wheel collar 98 will move out of engagement with toothed recesses 101 and the input pulley 45 will be free to rotate on the input shaft 24.

During normal operation, the cable 66 is in tension and exerts a force on a rocker arm 110 of an emergency release linkage 113, as shown in FIGS. 1B and 1C. The rocker arm 110 is pivotally mounted to the housing 21 by a bolt 117 as shown in FIG. 1C. A bracket 120 and a cable roller 123 direct the cable 66 along a line intersecting through a first end 126 of the rocker arm 110. The cable 66 may be connected to the first end 126 by a pin 129, for example. When the cable 66 is in tension, a second end 132 of the rocker arm 110 including a pressure foot 135 exerts a force against the bell crank 51 and the input pulley 45. (FIG. 1C shows an alternative embodiment of the non-pivotal connection of the input pulley 45 with the input shaft 24.) In this case, a toothed pocket wheel collar 138 is fixed to the input pulley 45. The toothed pocket wheel collar 138 and the input pulley 45 are axially slidable on the input shaft 24 for movement between a rotatable and a non-rotatable position engaging teeth and tooth recesses of a toothed input shaft connecter 141. In this case, the toothed input shaft connecter 141 includes a spring recess 144 having a biasing element 147 disposed therein in order to urge the toothed pocket wheel collar 138 and the toothed input shaft connecter 141 apart and out of toothed engagement. Thus, the embodiment of FIG. 1C will function generally the same as that of FIGS. 1A and 1B.

As may be appreciated, under normal operating conditions when the endless element or hand chain 48 is pulled, a rotational input is transferred by the input pulley 45 through the toothed pocket wheel collar 138 and the shaft connecter 141 to the input shaft 24. An input shaft sprocket 150 in turn exerts a force on an input chain 153 that is connected to an axle of the overhead door. Thus, during normal operation, a user may raise or lower the overhead door 12 by pulling the endless element or hand chain. When the hand chain or endless element 48 is not engaged, the door 12 is positively held against movement. At the same time, the emergency release linkage 113 provides a safety feature that will protect users, bystanders, other building occupants, and equipment in the case of an emergency.

In particular, the cable 66 is released in the case of a fire emergency when the fusible link is burned, for example. The result is that the rocker arm 110 is permitted to rotate about an axis 156 so that the pressure foot 135 moves toward the housing 21 and permits the bell crank 51 and input pulley 45 to move along the input shaft 24 out of engagement with the toothed input shaft connecter. With the toothed pocket wheel collar 98/138 disengaged from the input shaft connecter 103/141, the input shaft 24 is free to rotate inside the input pulley 45 without moving the pulley 45. Thus, dangerous whipping of the endless element 48, that would otherwise occur during falling of the overhead door 12 during a fire, is avoided. That is, in the case of a fire when a door is permitted to fall, the input pulley 45 and the endless element 48 would remain generally unaffected. It is to be noted that this feature of the invention provides an advantage in that a separate engagement lever is not required for engaging the input pulley 45. Rather, the input pulley 45 remains engaged except for during an emergency, in which case the input pulley will be automatically released for free rotational movement relative to the input shaft 24.

During normal operation, the load brake 42 stops the lower brake shaft 27 from moving when no force is being applied to the endless element 48. On the other hand, when a force is applied generally downward in a direction of arrow 159 as shown in FIG. 1B, the load brake 42 is moved into a released condition in which the load brake shaft 27 is permitted to rotate. This movement between braking engagement and a released condition is caused by a movement of the bell crank 51 about the input shaft 24. When a user pulls on the endless element 48, one of guides 162, 165 is urged toward alignment with the downward direction of pull. To provide this response, the guides 162 and 165 are spaced radially outward relative to a circumference of the input pulley 45. Thus, a downward force such as that indicated by arrow 159 causes the bell crank 51 to rotate. Rotation of the bell crank 51 in turn moves the actuator 54 in a downward direction also. As shown in FIG. 1B, the actuator 54 is connected to the hand crank release lever 57 by a bolt 167, for example. The hand crank release lever 57 may further be pivotally connected to the housing 21 by a bolt 170 and an eccentric 173 may be supported on the hand crank release lever 57. This eccentric 173 may be positioned on the hand crank release lever 170 so as to be pivotable about an axis 176 of the bolt 170. Thus, when the hand crank release lever 57 is rotated, the eccentric 173 rotates between load brake arms 182, 185 to move the load brake 42 between a braking position and a non-braking released position.

As shown in FIG. 1C, the eccentric 173 may include a set of prongs that progressively engage the arms 182 and 185 as the hand crank release lever 57 is rotated. In use, the hand crank release lever 57 and the eccentric 173 are positioned and configured to open the arms of the load brake 42 when a user pulls on the endless element 48 so that the load brake is released each time a user applies a force to one side or the other of the endless element 48. When the user releases the endless element 48, the bell crank 51 will return to a generally balanced equilibrium position in which the eccentric 173 does not force arms 182 and 185 apart.

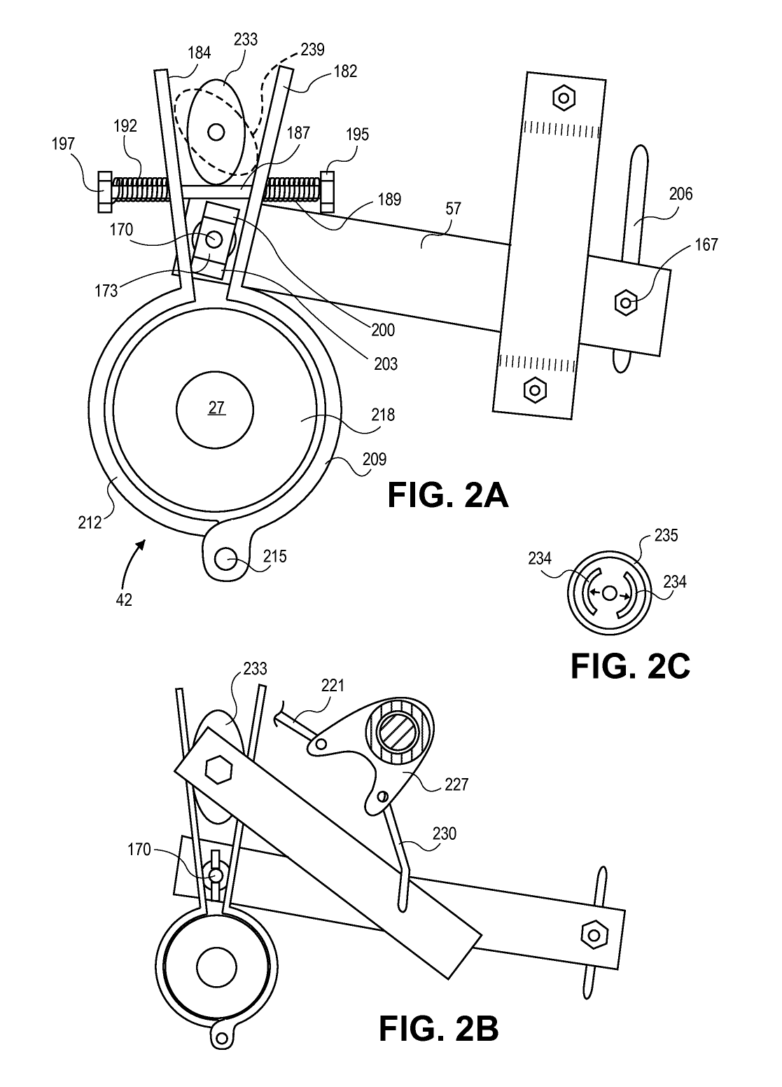

As may be appreciated from FIG. 1C, a bolt or other headed shaft 187 may extend completely through the arms 182 and 185 of the load brake 42. Respective spring elements 187 and 189 may be disposed between each of the arms 182 and 185 and respective heads 195 and 197. Thus the arms 182 and 185 are constantly biased inwardly toward each other and the load brake 42 is thereby urged into the braking condition. This relationship is perhaps best shown in the sectional view taken along lines 2A-2A of FIG. 1C and shown in FIG. 2A. Here the headed shaft 187 is shown in a side view with the spring elements 189 and 192 disposed between the arms 182 and 184 and the heads 195 and 197 of the bolt 187.

The hand crank release lever 57 is pivotable about the bolt 170 and has an eccentric including prongs 200 and 203. Thus when the bolt 167 moves one end of the hand crank release lever 57 up or down in a slot 206, the eccentric 173 is caused to engage and separate the arms 182 and 184. The arms 182 and 184 are connected to respective brake shoes 209 and 212 so that each arm and respective brake shoe is pivotable about a pivot pin 215 that may be provided in the form of a bolt supported on the housing 21 as shown in FIG. 1B. The brake shoes 209 and 212 surround a brake rotor 218 of the load brake 42. The brake rotor 218 is fixed on the load brake shaft 27 so that frictional contact by the brake shoes 209 and 212 on the brake rotor 218 causes the load brake shaft 27 to be stopped.

It is also important under emergency conditions for the load brake to be released so that the load brake shaft 27 is free to rotate in order to permit the door 12 to descend. To this end, additional components of the emergency release linkage have been provided. As referred to above, the emergency release lever 63 causes the load brake 42 to be released when tension is lost in the cable 66. When the tension is removed from the cable 66, the rocker arm 110 rotates in a clockwise direction as viewed in FIG. 1C. This movement in turn moves a link 221 in a direction of arrow 224. The link 221 is connected to an elbow link 227 pivotally supported on the input shaft 24. The elbow link 227 in turn moves and emergency release lever link 230 that connects the elbow link 227 to the emergency release lever 63. The emergency release lever 63 has an emergency release eccentric 233 fixed thereto. Advantageously, the emergency release eccentric 233 may be pivotally mounted together with the emergency release lever 63 to the housing 21 by a pivot pin 236, which may be provided in the form of a bolt, for example. The result is that when the cable 66 is released, the rocker arm 110 moves the links 221, 227, and 230 such that they rotate the emergency release lever 63 and the emergency release eccentric 233 about the pivot pin 236 so that the eccentric moves to a position indicated by the dashed lines 239 in FIG. 2A. As the eccentric 233 moves to this position, the brake shoes 209 and 212 moves to a position spaced from the brake rotor 218 so that the load brake shaft 27 is free to move. FIG. 2B additionally shows the relationship between links 221, 227 and 230. As shown in FIG. 2C, brake shoes 234 may be provided on an interior of a brake rotor 235 as an alternative to the configurations shown in FIGS. 1A through 2B, for example.

With the emergency release linkage 113 moved into a release condition, the input pulley 45 has been released to rotate freely on the input shaft 24. Furthermore, the load brake shaft 27 has been released to rotate freely within the shoes 209 and 212 of the load brake 42. The input shaft 24 is drivably connected to the overhead door axle by a belt or chain 153, and the load brake shaft 27 is drivably connected to the input shaft 24 by the load brake belt or chain 33. Thus, when the overhead door 12 is permitted to close under the force of gravity in a fire condition, for example, the load brake shaft 27 will be caused to rotate. In fact, as indicated by the reduction ratios shown in FIGS. 1A-1C, the load brake shaft 27 will be caused to rotate at a much greater speed than the rotation of the overhead door axle. This reduction has the advantage of permitting a lesser force applied by the load brake 42 to accomplish a much greater braking effect than would otherwise be possible. Furthermore, a high rate of speed of the load brake shaft 27 advantageously permits the use of the centrifugal clutch 39 for preventing the overhead door 12 from descending too fast. The torque reduction and/or speed increase may be selected to provide a predetermined maximum speed of descent for the overhead door. This predetermined speed of descent may be provided to inhibit damage to the door 12, other structural components associated with the overhead door 12, and the drive input device 10. Still further the maximum speed of descent may be selectively provided in a range that is acceptable for standard safety codes, for example.

The torque reduction and/or speed increase in the speed control portion of the drive input device generally corresponds to torque increase and/or speed reductions in the input portion of the device. Selection of required ratios to provide these increases and reductions may require a larger difference in sprocket sizes when the drive input device is implemented with larger or heavier doors, for example. Alternatively or additionally, one or more stages of reduction may be added in order to enable convenient lifting of the door and controlled descent of speeds of less or equal to the maximum speed permitted.

Another advantage of the present invention is that since the door 12 is locked against movement during normal operation, the door 12 need not be spring tensioned to a raised equilibrium position. Rather, the equilibrium position could be when the door is closed. Biasing the door 12 toward a closed position advantageously permits a non-motorized door to function as a fire door. Furthermore, with the present invention, the spring biasing need not be reset after an emergency or testing.

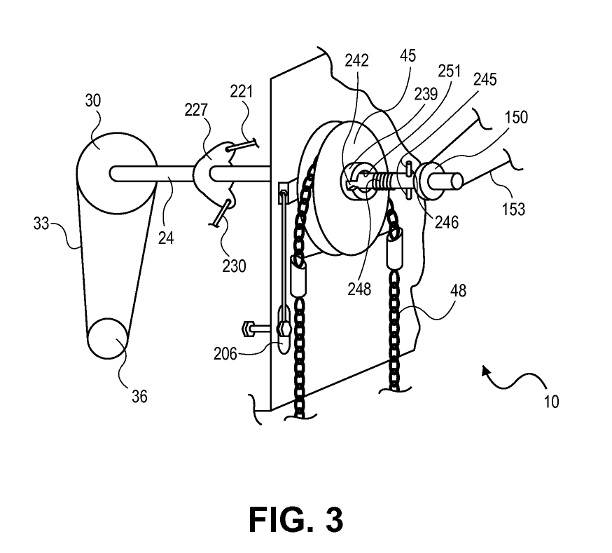

FIG. 3 is a perspective view of some of the components of the drive input device 10 of the present invention, as viewed in a direction of arrow 3 in FIG. 1C. As shown in FIG. 3, the components are in a somewhat exploded relation. A toothed pocket wheel collar 251 may be provided with a collar having toothed recesses or slots 242 for receiving teeth 245 in the form of ends of a pin 246 fixed in the input shaft 24. A spring 248 may be disposed between the teeth 245 and the tooth recesses 242. This spring 248 may be received in a spring recess 251, for example, to permit the teeth 245 to seat in the tooth recesses 242.

FIG. 4A is a perspective view of a drive input device 260 in accordance with a second embodiment of the invention. As with the previously described embodiment, a drive input device 260 may also be supported on the end plate 15 of an overhead door. The end plate 15 may include a mounting plate, or alternatively may have a mounting plate 18 attached thereto. An axle 263 of an overhead door extends through the end plate 15 and has an overhead door axle sprocket 266 mounted thereon. The input shaft 24 of the drive input device 260 may be drivable connected to the overhead door axle sprocket 266 by the input belt or chain 153 as described above. In the embodiment shown in FIG. 4A, a bell crank 269 is rotatably supported on the input shaft 24 between the input shaft driving sprocket 150 and an input pulley 272. The bell crank 269 has endless element guides 275 and 278 similar to those described above. Likewise, the endless element 48 may be substantially similar to that described above. In this regard it is to be understood that each of the belts, chains, and endless elements of the present invention may be provided by any of a variety of endless elements known or not yet discovered, which are capable of turning wheels or being turned by wheels of a variety of types. It is to be understood that these may be applied in any combination without departing from the spirit and scope of the present invention.

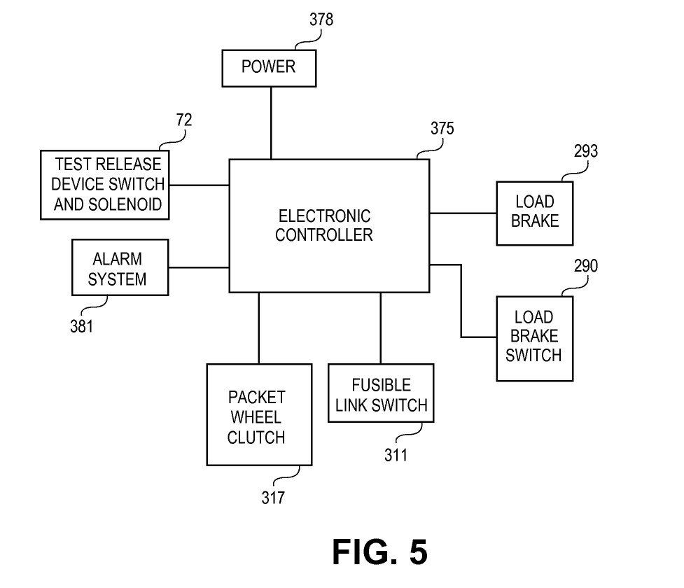

While the embodiment of FIGS. 4A through 5 functions similarly to the embodiment described above with regard to the FIGS. 1A through 3, it is to be understood that the embodiment of FIGS. 4A through 5 is an electrical version of the embodiment of FIGS. 1A through 3 above. Furthermore, it is to be understood that many advantages are provided by the various components that are unique to this embodiment, just as the embodiment of FIGS. 1A through 3 has advantages that are unique to itself. As shown in FIG. 4A, a resilient switch actuator lever 281 is connected to the bell crank 269 for actuation of the resilient lever 281 when the bell crank is rotated by a pulling action of a user on the endless element 48. As may be appreciated, the resilient lever 281 extends through a wall of a housing 284. As described above the input shaft 24 also extends through a wall of the housing 284 and is supported thereon.

FIG. 4B is a sectional view taken along lines 4B-4B of FIG. 4A and shows various components in greater detail. For example, the resilient lever 281 extends through a wall 287 and into a micro switch 290. The micro switch is connected to a load brake 293 either directly or via an electronic controller. When the resilient lever 281 is moved by rotation of the bell crank 269, the load brake 293 is actuated into a released condition. To this end, the load brake 293 may include a load brake rotor 296 having a rotor coil 299 therein. The load brake 293 may also include an armature 302 with a flex plate 305 movably connected to a base plate 308 fixed to the load brake shaft 27. The rotor 293 is fixed to the housing 287 so that in a non-actuated condition the flex plate 305 is magnetically attracted toward and fixedly engaged with the rotor 296. On the other hand, when the bell crank is moved and the micro switch 290 is activated, power to the coil 299 is removed and the flex plate 305 flexes back out of engagement with the rotor 296 into a released condition. Thus, the load brake shaft 27 is free to move relative to the rotor 296 when the power is off. The load brake could alternatively be made in reverse so that the load brake shaft 27 is released when power is supplied.

As described above a load brake shaft sprocket is connected to an input shaft transfer sprocket 30 by a load brake belt or chain 33. Thus, when the load brake 293 is in an engaged or braking condition, the input shaft 24 is prevented from rotating. On the other hand, when the load brake 293 is released, a drive input device is capable of transmitting an input from a user through the endless element 48, the input shaft 24, the input shaft driving sprocket 150, and the door input chain 153 to the overhead door axle 263. As may be appreciated, the bell crank 269 may be rotated in either direction as the endless element 48 is pulled on one side or the other. Accordingly, the resilient lever 281 is moved in one of a first and a second direction. As may be appreciated, a central position may correspond to a single “off” position while positions other than the neutral position may provide “on” positions with regard to the micro switch 290. Alternatively, a neutral position may provide an “on” position, and all other positions of the resilient lever 281 and the micro switch 290 may be “off” positions. In this regard, it is to be understood that the electronic controller may be configured to appropriately apply and remove power to the load brake 293 to release the load brake when a user pulls down on the endless element 48 to move the overhead door in either an opening or a closing direction. Furthermore, the flexibility of the resilient lever advantageously permits actuation of the microswitch 290 throughout a large range of motion of the bell crank 269 relative to the housing 284 without causing undue stress or structural damage to components of the drive input device 260.

The embodiments of FIGS. 4A and 4B also have an emergency release mechanism for releasing the input pulley 272 and the load brake 293 during an emergency condition. In this regard a sash or cable 66 similar to that described above is provided. The cable 66 extends out through a top of the housing 287 to a fusible link for release during a fire, for example. The cable 66 is connected to a micro switch 311 fixed to an interior of the housing 287 as shown in FIG. 4B, for example. An emergency release spring 314 may be connected to the micro switch 311 and to the housing 287. This spring 314 is configured to urge the micro switch 311 into an “off” position so that when there is a tension provided in the cable 66 then the micro switch 311 will remain in an “on” condition. On the other hand, when the tension is released in the cable 66, the bias of the emergency release spring 314 moves the micro switch into the “off” condition. In turn, the micro switch 311 can automatically remove power to the load brake 293 and thereby release the load brake shaft 27 to rotate freely relative to the load brake 293. Alternatively, the electronic controller can process the signals from the micro switches 311 and appropriately actuate the load brake 293.

In addition to actuation of the load brake 293, a release of tension in the cable 66 can also effectuate a release of the input pulley 272 from non-rotative engagement with the input shaft 24. The release of the input pulley 272 relative to the input shaft 24 may be provided by a second clutch or a drive clutch 317 that controls rotational movement of the input pulley 272 relative to the input shaft 24. As shown in FIG. 4B, the drive clutch 317 has a rotor 320 mounted on the housing 287 by a bracket 323. The drive clutch 317 also has an armature 326 with a flex plate 329 releaseably engaging the rotor 320 and a base plate 332 fixed to the input shaft 24. Thus, when power is removed from a coil 335 within the rotor 320, the flex plate 329 is urged by springs out of engagement with the rotor 320 so that the input pulley 172 is free to rotate on the input shaft 24 similar to the release of the input shaft described with regard to FIGS. 1A through 3 above. Thus, in an emergency release condition with the input pulley 272 released for free rotational movement on the input shaft 24 and with the load brake shaft released for free rotational movement relative to the load brake 293, the drive input device 260 of the present invention is in a condition for permitting an overhead door associated therewith to close under the force of its own weight similar to that described with regard to FIGS. 1A through 3 above. Likewise, the centrifugal clutch 39 is provided on the load brake shaft 27 and interconnects the load brake shaft 27 with the housing 287 so that the load brake shaft 27 is inhibited from rotating at speeds greater than a predetermined maximum speed as described above.

FIG. 4C is a detailed view of a region 4C of FIG. 4B. As may be appreciated from the sectional view of FIG. 4C, the coil 335 may be provided in a secure manner within a rotor 338 similar to the rotor 320. As shown, the input pulley 272 may be advantageously be provided as an integral extension of the rotor 338. FIG. 4C shows the armature 341 fixed to the input shaft 24 by a set screw 344. However, any of a variety of fastening or fixing mechanisms may be implemented for supporting the armature 341 on the input shaft 24. The armature will have a flex plate 347 similar to the flex plate 329 of FIG. 4B. Additional details of the flex plate 347 shown in FIG. 4C include a wear pad 350 of a wear resistant material for engagement with a wear pad 353 supported on the rotor 338 to provide a good frictional engagement when power is applied to the rotor coil 335. As shown in FIG. 4C one or the other or both wear pads 350, 353 may be supported, at least in part, by resilient members 356.

FIG. 5 is a diagrammatic view of an electronic controller 375 that may be connected to the various electrical components of the embodiments shown and described with regard to FIGS. 1A through 4C above. As such the electronic controller may be like the electronic controller 92 shown in FIG. 1A, or may be a more complex device as will be described below. Alternatively or additionally, the electronic controller 375 could include the electronic controllers shown and described in co-pending U.S. patent application Ser. No. 10/645,004, filed Aug. 20, 2003, and entitled FIRE DOOR CONTROL SYSTEM AND METHOD INCLUDING PERIODIC SYSTEM TESTING; U.S. patent application Ser. No. 10/631,315, filed Jul. 30, 2003, and entitled FIRE DOOR CONTROL SYSTEM AND METHOD; and U.S. patent application Ser. No. 10/777,502, filed Feb. 10, 2004, and entitled FIRE DOOR CONTROL SYSTEM, METHOD INCLUDING PERIODIC SYSTEM TESTING, AND CONTACTLESS SAFETY EDGE, all by Rob J. Evans, the disclosures of which are each incorporated herein by reference. As may be appreciated, the electrical components including the electronic controller 375 may be supplied with power from a power source 278. The power source 278 may include an AC power source of a 120 or 220 volts, for example. Alternatively, the power source may be provided by a DC power source from one or more batteries, for example. The power source may also include a converter that transforms AC power into DC power, for example. Furthermore, the power source may include a charger for recharging the one or more batteries in a power supply system. It is to be understood that the electrical components of the present invention may include or be associated with the primary power source supplied by or transformed from an AC power supply, and an auxiliary power source supplied by a DC power source that may be charged by the AC power source.

The electronic controller 375 may be connected to the load break micro switch 290 and the load brake 293 described above. The electronic controller may be connected with a fusible link or the emergency release switch 311 associated with the emergency release switch 311. This fusible link or emergency release switch 311 may also be termed a pocket wheel clutch switch since it releases the pocket wheel clutch in an emergency condition. The electronic controller is also connected to the pocket wheel or drive clutch 317 for providing engaged and released conditions corresponding to normal and emergency operating conditions, respectively. The electronic controller may also be connected with an alarm system 381. As such, the electronic controller 375 can control the various electrical components in accordance with signals received from the alarm system 381. For example, in addition to responding to loss of tension in the cable 66 due to burning of the fusible link 69, the electronic controller may receive signals from sensors located in pertinent locations in a building having the overhead door 12 and the drive input device 10 therein.

The electronic controller 375 may also be connected with the test release device 72/423 shown in FIG. 1A. Furthermore, the drive input device 260 of FIGS. 4A-5 may be automatically reset to an initial condition of use whenever the system is reset. The system may be reset by opening the door 12 completely after an emergency condition, or by pressing a button. The drive input device 260 could be reset by the electronic controller 375 automatically moving the load brake into an engaged condition preventing movement of the drive input unless the endless element is pulled by a user when an emergency condition has been removed. Likewise, the second clutch or drive clutch 317 could also be automatically engaged by the electronic controller when the emergency condition is removed. Test release devices 72/423 associated with the electrical embodiments of FIGS. 4A-5 may also need to be reset manually, although a solenoid of the test release devices could be automatically reset by the electronic controller 375 when an emergency condition is removed. The systems may be automatically reset when the test release device 72/423 is manually reset. Alternatively or additionally, in configurations without the test release devices 72/423, the systems may be automatically, continuously, and repeatedly reset each time a user releases the endless element.

The test release device 72/423 may be applied with each of the embodiments of the present invention, and may also be advantageously applied on other overhead door systems. An interior of the test release device 72/423 may include a switch connected to a solenoid for actuation of the solenoid 387. The solenoid may be connected to a lever. The lever may be pivotally supported in a lever cable connector housing. The lever may be configured to be releaseably engaged in an aperture of a slidable link. The slidable link may be supported in a channel of the lever cable connecter housing. The slidable link may have a cable aperture on a first end thereof for connection with the cable 66. The slidable link may also have a retaining member on a second end thereof for engagement with an end wall of the channel. Thus, when the solenoid is actuated in response to a user pressing the button 84, as shown in FIG. 1A, the switch is activated and in turn actuates the solenoid to move a solenoid plunger. An opposite end of the lever may thereby be moved in an opposite direction. When the lever moves, the lever slides out of the aperture of the slidable link. A tension in the cable 66 causes the slidable link to move upward. In this position, the cable 66 has moved in a direction away from the test device 72/423 sufficiently to simulate loss of tension due to burning of a fusible link, for example. However, the retaining member on the slidable link has retaining structure that prevents the slidable link from sliding completely out of the lever cable connector housing. Thus, after the test has been performed, the user may easily reset the test release device by moving the slidable link back to its original position in which the lever once again engages the aperture 396. Thus, the test release device 72/423 of the present invention advantageously eliminates the need for replacing fusible links and/or resetting slashes or cables for an overhead fire door system after emergency release testing.

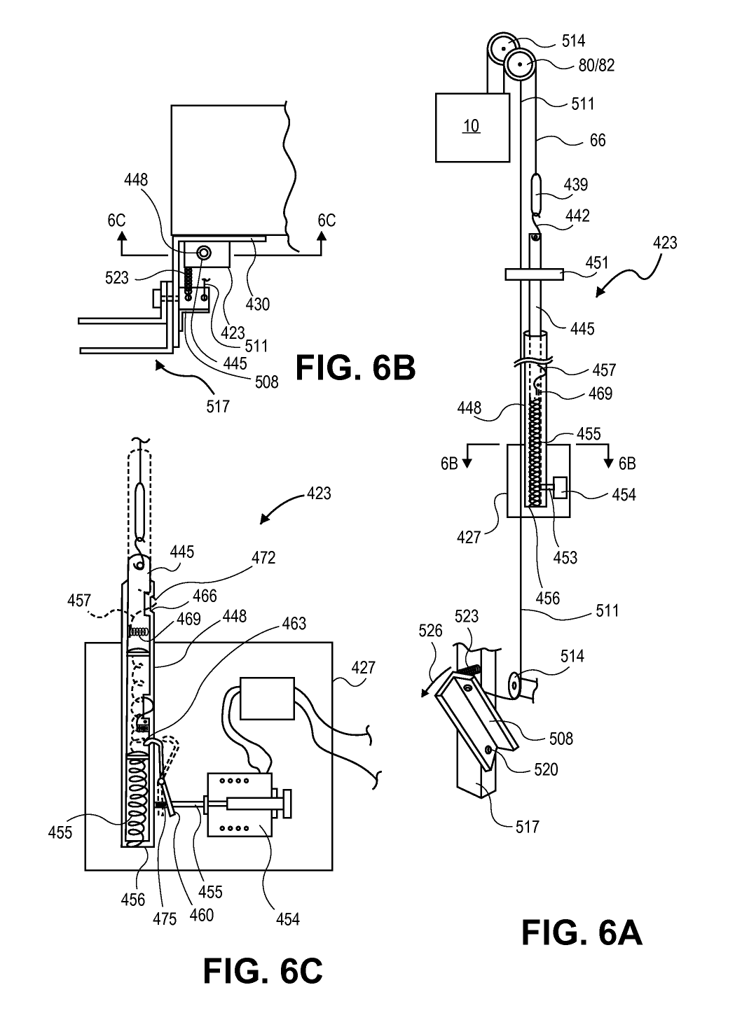

FIGS. 6A-6C show an exemplary embodiment of an automatic test device 423. The automatic test device 423 may function generally similarly to the automatic test device described above. Many of the elements of the test device 423 may be similar to those of the test device 72 and are not explicitly described with regard to test device 423 to avoid redundancy. Other elements are unique and are described in greater detail below in order to bring out the structural and functional differences as well as the advantages of the automatic test device 423.

The test device 423 may have a housing 427 similar to that shown and described with regard to test device 72 in FIG. 1A. On the other hand, the housing 427 may be made small so that it may be easily mounted on a door frame channel 430 as show in FIG. 6B. Thus, the entire test device 423 may be conveniently mounted on the channel 430, and may only extend away from the vertical track a few inches. This provides the advantage of eliminating the need for additional mounting structure that may be located away from an overhead door with which it is associated.

FIG. 6A also shows how the automatic test device 423 is connected to the drive input device 10 via a cable, fusible link 439, and an S-hook. The S-hook may be connected to an upper end of an inner telescoping tube 445. The inner telescoping tube 445 may be slideably and resiliently supported in an outer receiving tube 448 for movement between a lowered set position and a raised released position.

The outer receiving tube 448 may be fixed to and extend outwardly through a wall of the housing 427. The inner tube 445 may have a cross bar handle 451. A user may return the inner tube 445 to the lowered set position after testing the system with the automatic test device 423. The inner tube 445 may be held in the lowered set position by a pin 453 connected to a solenoid 454. The pin 453 may engage the inner tube directly through an aperture in the outer tube, or the pin 453 may engage a spring biased lever as will be described in greater detail below. The inner tube 445 receives and compresses a spring 455 against a lower wall 456 of the outer tube 448 or a wall of the housing 427. Thus, the inner tube is urged in an upward direction out of the outer tube 448. However, the solenoid 454 and the pin 453 hold the inner tube in its lowered set position until the solenoid is actuated by the a switch similar to switch 84 of the test device 72 shown in FIG. 1A. When the solenoid releases the inner tube, the spring 455 expands and moves the inner tube 445 upward. A spring biased retaining member 457 may be provided in the inner tube. The retaining member 457 may be urged to extend outward and engage a slot 460 in the outer tube 448 when the inner tube is raised to a predetermined height by the spring 455. Thus, the inner tube 445 does not come completely out of the outer receiving tube 448, and ease of resetting and returning the system to an operation mode may be provided.

The spring 455 may be configured to move the inner tube 445 a distance that is much greater than required to release the cable 436 and actuate the door releasing mechanism in the input drive device 10. For example, the spring may bias the inner tube to move six or more inches between the lower set position and the raised released position, while a movement of only an inch or two may be needed in order to test the system. Thus, a factor of safety of three times or more than the distance required may be provided.

FIG. 6C is a sectional view of the automatic test device 423 taken along lines 6C-6C of FIG. 6B and shows the inner components and additional details of the test device 423. For example, the pin 455 may engage a spring biased release lever 460 that in turn engages and disengages a notch 463 in the inner tube 445 in response to actuation of the solenoid 454. When the spring biased lever is released from the notch 463, the inner tube may be positively urged upwardly by the spring 455 to the raised released position shown in dashed lines in FIG. 6. As the inner tube 445 moves from the lowered set position to the raised released position, the retaining member 457 may slide along an interior surface of the outer tube 448 until the retaining member 457 moves into alignment and engages in a slot 466. A spring 469, associated with the retaining member 457, may engage a lever of the retaining member 457 and urge a pawl 472 into the slot 466 when the pawl 472 reaches a position of alignment therewith.

Once the test has been performed, the automatic test device may be reset. To reset the automatic test device, the user may simply engage the pawl 472 with his or her finger and press it in until is moves out of engagement with structure forming the slot 466. At the same time, the user may grasp the handle 451 and force the inner tube 445 downward to its lowered set position. When the inner tube reaches the lowered set position, the release lever 460 is automatically biased by a spring 475 to engage the notch 463. Once the release lever engages the notch 463, the automatic test device has been reset and the handle 451 may be released.

As may be appreciated, the present invention has been described in specific terms with reference to particular embodiments shown in the figures. However, many other configurations are possible without departing from the spirit and scope of the invention. For example, the tubes 445, and 448 need not be tubes, but could be provided in other forms. While the springs of the test device have been shown and described as compression springs, it is contemplated that tension springs could be implemented instead. Furthermore, the orientation of the automatic test device and/or its various components could be changed without departing from the scope of the invention. While a single pawl 472 of the retaining lever 457 and a single release lever are shown and described, it is contemplated that two or more pawls and two or more release levers could be provided for redundancy. Furthermore, the inner and outer tubes 445, 448 could be provided with guide structure that keeps them from rotating relative to each other. Such a guide structure could thus assure alignment of the pawl 472 with the slot 466 and the release lever 460 with the notch, for example.

The automatic test device 423 of the present invention has the advantage of positively slackening the cable 436 by the urging of the spring 455. The release of the cable 436 and the urging of the cable 436 and the rocker arm 110 by biasing elements 107 and 147 that are shown in FIGS. 1B and 1C provide a measure of redundancy assuring that the automatic test device will function properly to release the cable and rocker arm. Furthermore, the automatic test device may be installed on any overhead door system to provide easy testing and easy resetting. The release of the door by the input drive device and automatic test device may be effected by the mechanisms described above. These mechanisms make up part of the control system and automatic test device of the present invention. Therefore, the present invention has the advantage of not relying upon counter balance spring adjustment, corrosion, and other factors of an overhead door in order to lower the door during an emergency or in a test. Rather, release of the door is positively assured in the drive input device and the automatic test device.

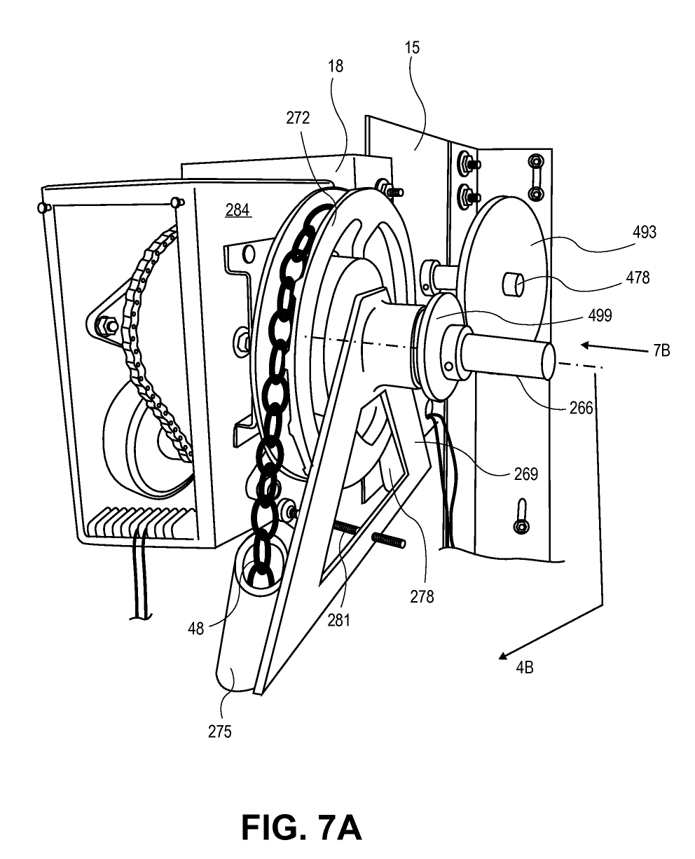

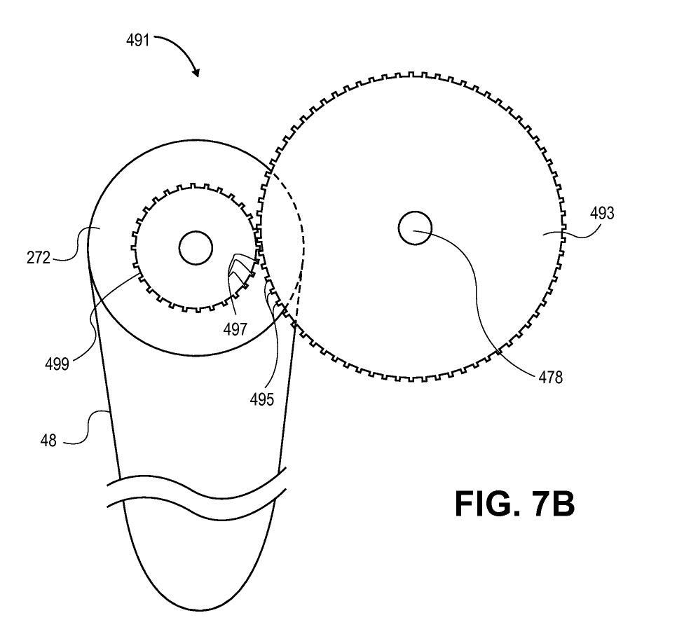

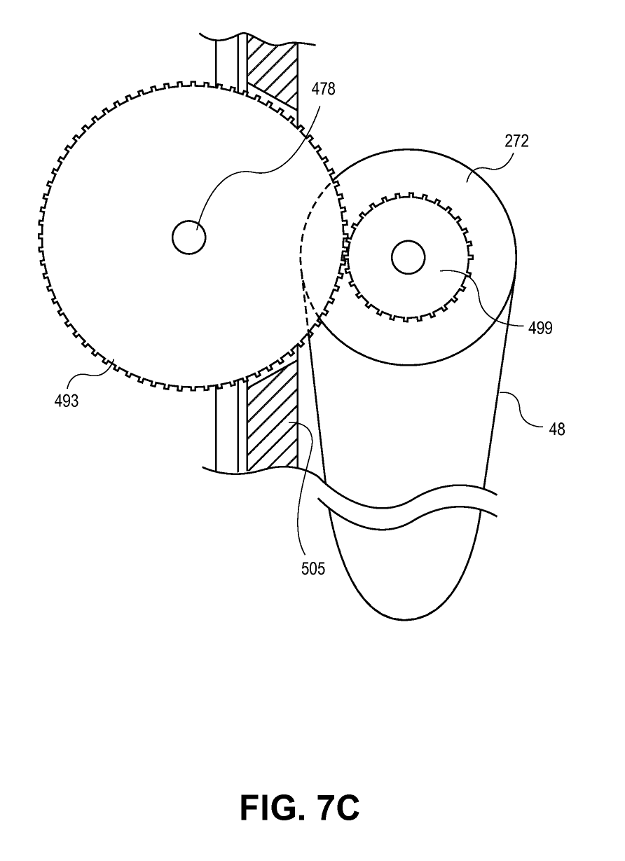

FIG. 7A is a diagrammatic end view of an alternative driving connection for drivably connecting the drive input devices 10 and 260 of the present invention to on overhead door axle 478. The driving connection in FIG. 7A shows a gear to gear connection 491 instead of the sprocket and chain connections shown in the other figures. It is to be understood that the gear to gear connection 491 may be implemented without loss of function as compared with the drive connections shown in FIGS. 1A-6C. Furthermore, the gear to gear connection 491 may provide the advantage of improved safety over the sprocket and chain connections. For example, if the chain of a sprocket and chain connection were to break, then the door would be free to fall freely and could cause injury to people and/or damage to door and associated structures. On the other hand, the gear to gear connection 491 has a door axle gear 493 mounted on the door axle 478. Teeth 495 of the door axle gear 493 mesh with teeth 497 of a drive input gear 499 so that there is a positive driving connection between the door axle gear 493 and the drive input gear 499, as shown in the schematic end view of FIG. 7B taken in a direction of arrow 7B of FIG. 7A. Alternatively, one or more additional gears may be interposed between the door axle gear 493 and the input drive gear 499 as desired. These additional gears may be idler gears to provide a positive driving connection, to provide proper spacing, and/or to enable a desired gear reduction.

FIG. 7C shows an alternative configuration for the gears 493 and 499. This configuration locates the endless element 48 on an exterior of a building wall 505. To this end, the door axle gear 493 may extend through the wall 505. Additional gears or a drive chain may be used to drivably connect a hand hoist on an exterior of the wall 505 with the overhead door axle 472 on an interior of the wall 505. Thus, a fireman or other person may raise and/or lower the door from an exterior thereof. This configuration provides another advantageous feature of enabling control of the door from outside the building.

Another advantageous feature may be provided by a foot pedal 508 that may be provided at the bottom of the door as shown in FIG. 1A. The foot pedal 508 may extend interiorly or exteriorly away from the wall in which the door is mounted. The foot pedal is connected to a first end of a line 511. The line extends upwardly and may be guided by one or more shiv wheels 514 to enter the housing 21. As shown in FIGS. 1B and 1C, the line 511 is guided into the housing and is connected to the rocker arm 110 together with the release cable 66. Thus, when tension in the cable 66 is released, the rocker arm releases pressure on the teeth 105 and 107 that permit driving input from the endless element 45. The rocker arm 110 will remain in a released position until the system has been reset as has been described above. Likewise, the door 12 will have reached its fully closed state. The foot pedal 508 is normally biased into a rotated up position and the line 511 is in a relaxed state having little or no tension. Once the door has been lowered and the rocker arm has been released, a user may advantageously engage the foot pedal 508 and press it downward in order to tension the line 514 and at least temporarily engage the teeth 105 and 107, as may be appreciated by viewing FIGS. 1B and 1C. Pressing the foot pedal 508 down may completely overcome the bias of one or more springs having small spring constants and may thus be accomplished by a light pressure from a user's foot. Thus, a fireman or other user may approach the door and press the foot pedal 508 down and simultaneously pull on the endless element 48 to lift the door out of the closed position for access therethrough. This foot pedal mechanism disposed interiorly provides a safety mechanism whereby an individual trapped inside a building during an emergency situation with the fire door down can still escape by engaging the foot pedal 508 and raising the door with the hand hoist. Once the fireman or other person has assessed conditions or obtained access through the door, he or she may release the foot pedal 508. As a result the foot pedal 508 will be biased into its released position, the teeth 105 and 107 will be disengaged from each other, and the door will close at a rate controlled by the speed control device, which may be provided as a centrifugal clutch 39.

As shown in FIG. 6A, the foot pedal 508 may be formed of an angled channel pivotally connected at a first end to a track 517 or other structure by a bolt 520, for example. The other end of the foot pedal 508 may be resiliently connected by a spring 523 to the track 517 or other structure. Thus, when the foot pedal 508 is pressed down in a direction of arrow 526, the line 511 is pulled, the rocker arm is actuated, and the teeth 105 and 107 are engaged. While holding down the foot pedal 508, a user may thus advantageously raise the door without having to replace a fuse link and/or reset the system.

The present invention has many advantages. One of the advantages of the present invention is that it enables a fire door system that does not require extensive efforts in resetting the tension spring of an overhead fire door after testing the door or after an actual emergency event. As set forth above, with the present invention, tension springs for overhead doors need not be pre-tensioned to maintain the overhead door 12 in a raised position. Therefore, extensive effort in pre-tensioning the doors is eliminated. Another advantage of the present invention is that any of the various embodiments may be easily retrofitted to existing doors. The present invention may be applied to thermal insulated doors. The invention may be applied to service doors that may be insufficiently sprung. It is to be understood that the present invention may be used to provide a safety hoist on coiling doors, sectional doors, vertical lift doors, high lift doors, standard lift doors, low headroom doors, sliding doors, sliding doors, thermal service doors, grills, and gates, for example. The present invention may be applied to any of these doors or other closures that may also be configured as thermal doors or barriers. These doors and barriers may be referred to as “thermal rated”, and it is to be understood that the present invention may be implemented with any such door or barrier. Furthermore, it is to be understood that in the event that a spring should break when loaded during closure, for example, the door would be controlled by either the load break or the speed control clutch to control or inhibit descent of the door.

It is to be noted that the mechanical and electrical embodiments disclosed herein have many components in common. As many as eighty-five percent or more of the components may be common for both the mechanical and the electrical embodiments. As such, conversion from a mechanical embodiment such as that shown in FIGS. 1A-3 to an electrical embodiment as shown in FIGS. 4A-5 and 7A may be performed efficiently and without great losses with regard to components. Furthermore, both of the electrical and mechanical embodiment may incorporate direct gear to gear drive connections between the input pulley and the door axle. The sizes of the gears, pulleys, sprockets, and pocket wheels may be varied to provide a desired combination. This combination may depend, at least in part, on the size of the door to be controlled.

The embodiments of the invention described herein are exemplary and numerous modifications, variations and rearrangements can be readily envisioned to achieve substantially equivalent results, all of which are intended to be embraced within the spirit and scope of the invention.

1. An overhead door control system, comprising:
an input shaft drivably connected to an overhead door axle;
a load brake shaft drivably connected to the input shaft; and
a load brake which releases the load brake shaft in response to rotation of the input shaft.

2. The system of claim 1, wherein the load brake engages the load brake shaft in response to the rotation of the input shaft being driven to zero.

3. The system of claim 1, further including a first clutch connected to the load brake shaft, the first clutch inhibiting the rotation of the load brake shaft above a predetermined speed.

4. The system of claim 1, further including an emergency release mechanism which releases the input and load brake shafts in response to an emergency condition.

5. The system of claim 3, further including an input pulley drivably connected to the input shaft with a second clutch.

6. The system of claim 5, wherein the second clutch allows the input pulley to rotate relative to the input shaft in response to an emergency condition.

7. The system of claim 1, wherein the load brake includes first and second load brake shoes pivotably connected together.

8. The system of claim 7, wherein the load brake shoes pivot relative to each other in response to rotation of the input shaft.

9. The system of claim 8, wherein the load brake includes a brake rotor coupled with the load brake shaft, the first and second load brake shoes releasing the brake rotor in response to rotation of the input shaft.

10. The system of claim 1, further including first and second chains, the first chain drivably connecting the input and load brake shafts together and the second chain drivably connecting the input shaft and overhead door axle together.

11. An overhead door control system, comprising:
an input shaft drivably connected to an overhead door axle;
a load brake shaft drivably connected to the input shaft;
a load brake which releases the load brake shaft in response to rotation of the input shaft; and
a first clutch connected to the load brake shaft, the first clutch inhibiting the rotation of the load brake shaft above a predetermined speed.

12. The system of claim 11, wherein the load brake engages the load brake shaft in response to the rotation of the input shaft being driven to zero.

13. The system of claim 11, further including a second clutch and an input pulley, wherein the input pulley is drivably connected to the input shaft with the second clutch.

14. The system of claim 13, wherein the second clutch allows the input pulley to rotate relative to the input shaft in response to an emergency condition.

15. The system of claim 11, further including an input pulley drivably connected to the input shaft with a second clutch.

16. The system of claim 11, further including an emergency release mechanism which releases the input and load brake shafts in response to an emergency condition.

17. The system of claim 11, wherein the load brake includes first and second load brake shoes pivotably connected together. The system of claim 67, wherein the load brake shoes pivot relative to each other in response to rotation of the input shaft.

18. The system of claim 17, wherein the load brake includes a brake rotor coupled with the load brake shaft, the first and second load brake shoes releasing the brake rotor in response to rotation of the input shaft.

19. The system of claim 11, further including first and second chains, the first chain drivably connecting the input and load brake shafts together and the second chain drivably connecting the input shaft and overhead door axle together.
